(19) United States
(12) Patent Application Publication
(10) Pub. No.: US 2024/0276176 A1
(43) Pub. Date: Aug. 15, 2024

(54) PERSONAL SAFETY MESSAGE TRANSMISSION INITIATION AND CESSATION BASED ON USER EQUIPMENT INFERENCES

(71) Applicant: QUALCOMM Incorporated, San Diego, CA (US)

(72) Inventor: Dan VASSILOVSKI, Del Mar, CA (US)

(21) Appl. No.: 18/169,747

(22) Filed: Feb. 15, 2023

(51) Int. Cl. H04W 4/029; G08G 1/01; G08G 1/04; H04W 4/02

(52) U.S. Cl. CPC H04W 4/029; G08G 1/0116; G08G 1/012; G08G 1/04; H04W 4/027

(57) ABSTRACT

Certain aspects of the present disclosure provide techniques for a user equipment (UE) associated with a vulnerable road user (VRU) to determine to initiate or cease transmission of messages indicating VRU characteristics. A method that may be performed by a UE includes: detecting at least a first condition that indicates the UE is associated with a vulnerable road user (VRU); and initiating transmission of one or more messages indicating VRU characteristics in response to the detection.

### BACKGROUND

### Field of the Disclosure

Aspects of the present disclosure relate to wireless communications, and more particularly, to techniques for a user equipment (UE) associated with a vulnerable road user (VRU) to determine to initiate or cease transmission of messages indicating VRU characteristics.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes detecting at least a first condition that indicates the UE is associated with a vulnerable road user (VRU); and initiating transmission of one or more messages indicating VRU characteristics in response to the detection.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A-5B show diagrammatic representations of example vehicle-to-everything (V2X) systems.

FIG. 6 illustrates an example environment in which a V2X system may be employed.

FIGS. 7A and 7B illustrate example scenarios of a UE initiating and ceasing transmission of messages indicating vulnerable road user (VRU) characteristics, in accordance with aspects of the present disclosure.

FIG. 8 depicts a process flow for communications in a network between a UE and a roadside unit or a vehicle.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for a user equipment (UE) associated with a vulnerable road user (VRU) to determine to initiate or cease transmission of messages indicating VRU characteristics.

The Society of Automotive Engineers (SAE) has developed standards regarding Personal Safety Messages (PSMs) to enable CV2X-capable UEs held by pedestrians, cyclists, and other vulnerable road users (VRUs) to broadcast location, motion state, path history, and path prediction information to other CV2X devices, such as vehicles and RSUs. Per the standard governing the PSM (SAE J2945/9), PSM transmission frequency is between 1 Hz and 10 Hz, with the exact frequency determined by several criteria based on VRU activity. The European Telecommunications Standards Institute (ETSI) has developed standards for VRU awareness messages (VAMs) that may be similar to PSMs. Other jurisdictions may develop standards for messages that indicate one or more characteristics (e.g., location, motion state, path history, or path prediction information) of VRUs. UEs used by VRUs (e.g., pedestrians or cyclists) are typically operated without external power. As such, it is desirable to minimize power consumption of these UEs. Transmission and reception of PSMs and other messages indicating characteristics of VRUs can substantially increase UE power usage. In addition, transmission of the messages by UEs of users that are not actually vulnerable consumes radio frequency resources and can mislead other devices regarding the presence of VRUs.

The present disclosure describes techniques for a VRU UE to determine when it should initiate and cease transmission of messages indicating VRU characteristics (e.g., PSMs or VAMs) based on current environment, paired devices, location, motion state, detected ambient audio, and/or detected proximate vehicles and VRUs. In addition to possibly reducing UE power consumption, aspects of the present disclosure may also reduce “nuisance” message transmission; specifically UEs in cars, buses, trains, and/or subways will not transmit messages that could mislead or cause receiving UEs (e.g., roadside units (RSUs), vehicles, other VRUs) to incorrectly interpret the presence of the user. In addition, such UEs may avoid using over-the-air resources for messages that the UEs cease transmitting. The UEs may implement an algorithm for initiation and cessation of PSM transmission based on UE-detected environmental information, UE-detected VRU activity, and/or UE historical (learned) data.

By implementing an algorithm for a UE to determine to initiate or cease transmitting messages indicating VRU characteristics (e.g., PSMs or VAMs), UEs may both reduce their power consumption and prevent the transmission of nuisance messages.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

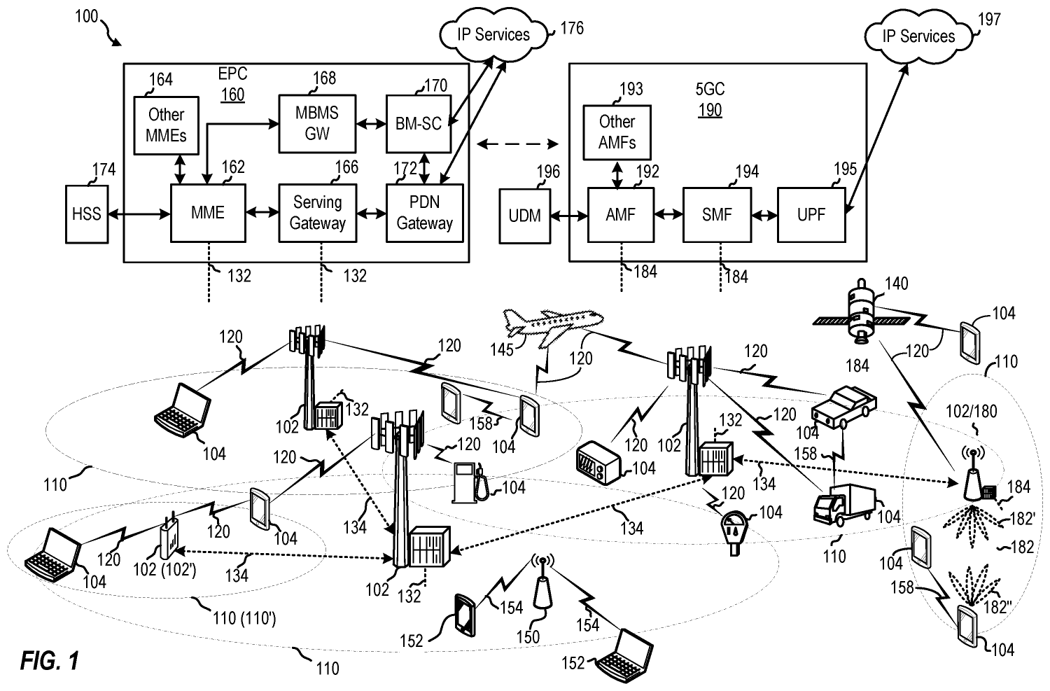

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

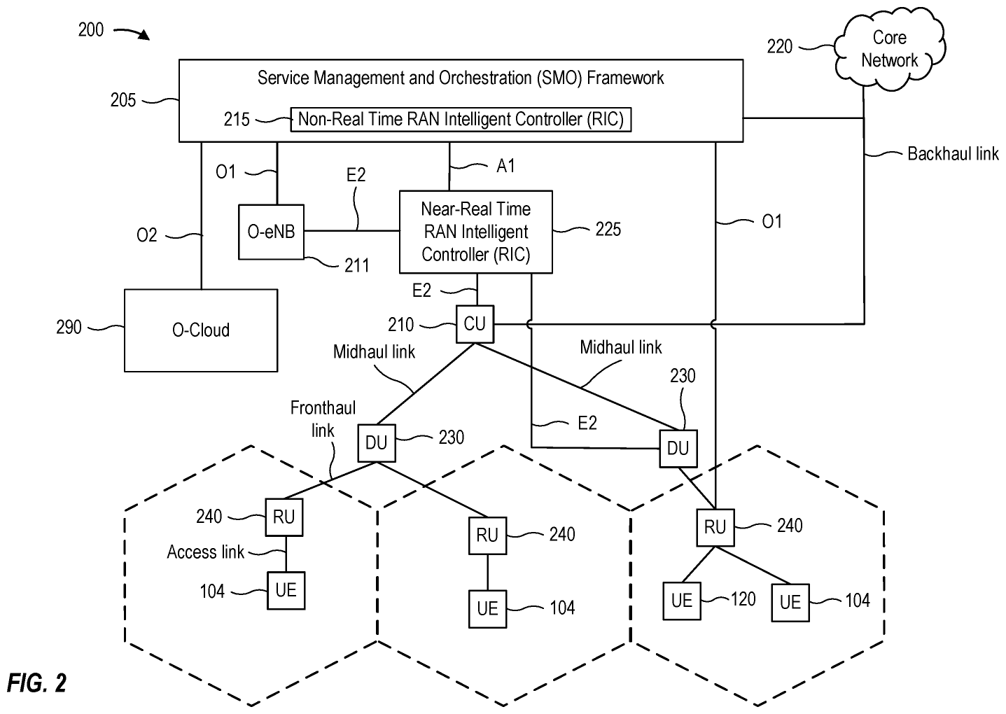

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

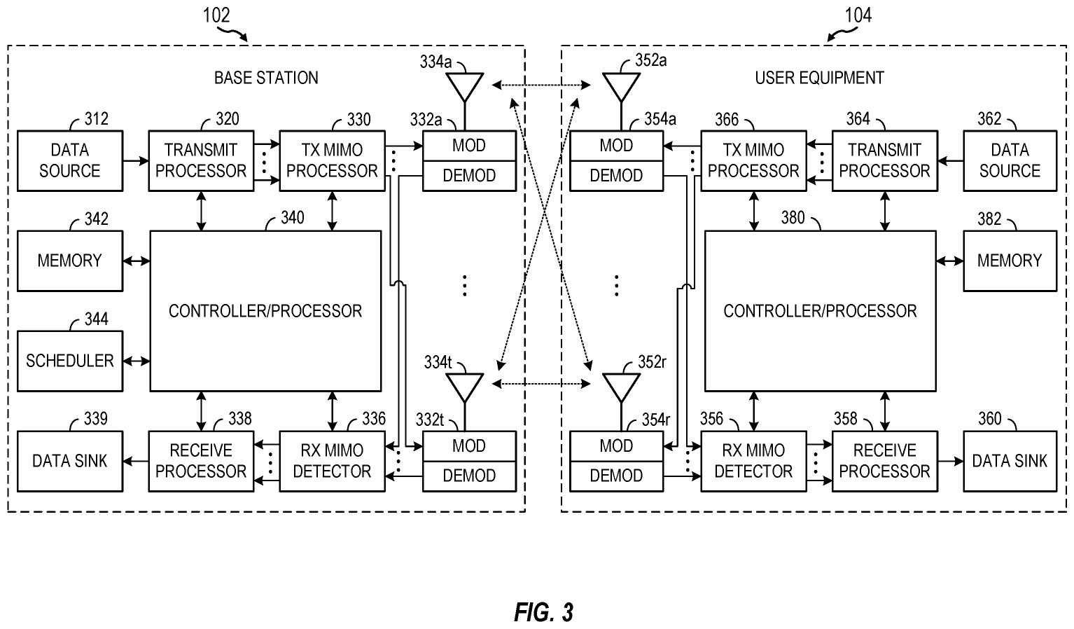

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

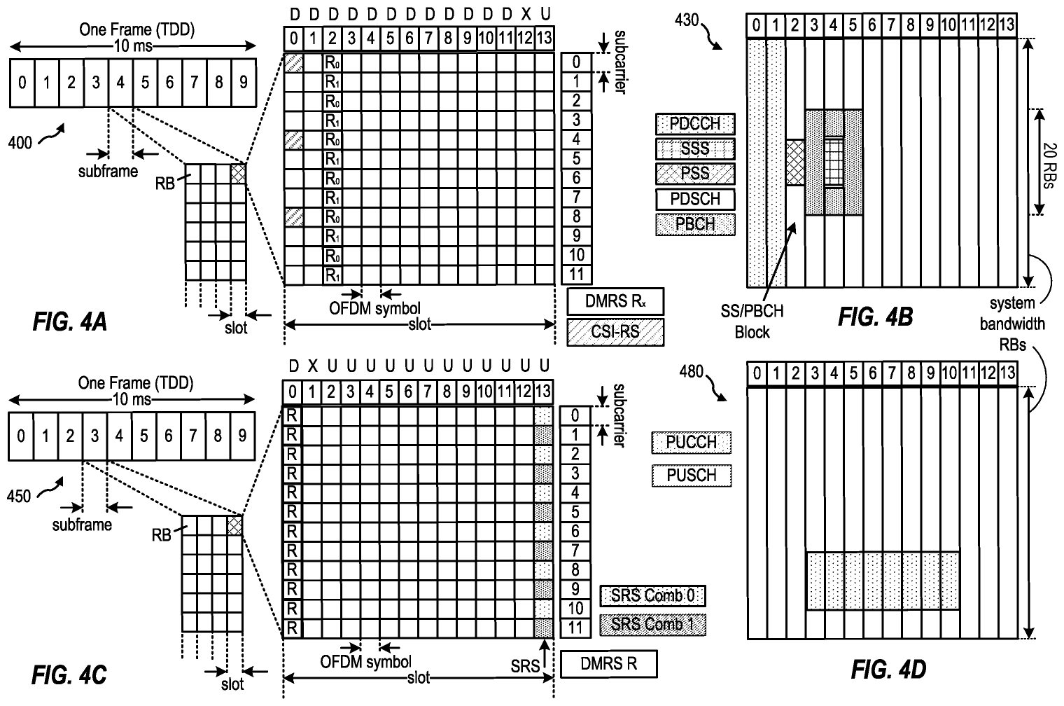

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Sidelink Communication

In some examples, two or more subordinate entities (e.g., user equipments (UEs) 104) may communicate with each other using sidelink signals. Real-world applications of such sidelink communications may include public safety, proximity services, UE-to-network relaying, vehicle-to-vehicle (V2V) communications, vehicle-to-everything (V2X), Internet of Everything (IoE) communications, IoT communications, mission-critical mesh, and/or various other suitable applications. Generally, a sidelink signal may refer to a signal communicated from one subordinate entity (e.g., UE 104) to another subordinate entity (e.g., another UE 104) without relaying that communication through the scheduling entity (e.g., UE 104 or base station (BS) 102), even though the scheduling entity may be utilized for scheduling and/or control purposes. In some examples, the sidelink signals may be communicated using a licensed spectrum (unlike wireless local area networks, which typically use an unlicensed spectrum). One example of sidelink communication is PC5, for example, as used in V2V, long term evolution (LTE), and/or new radio (NR).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations, resource reservations, and other parameters used for data transmissions, and the PSSCH may carry the data transmissions. The PSFCH may carry feedback such as acknowledgement (ACK) and or negative ACK (NACK) information corresponding to transmissions on the PSSCH. In some systems (e.g., NR Release 16), a two stage sidelink control information (SCI) may be supported. Two stage SCI may include a first stage SCI (SCI-1) and a second stage SCI (e.g., SCI-2). SCI-1 may include resource reservation and allocation information, information that can be used to decode SCI-2, etc. SCI-2 may include information that can be used to decode data and to determine whether the UE is an intended recipient of the transmission. SCI-1 and/or SCI-2 may be transmitted over PSCCH.

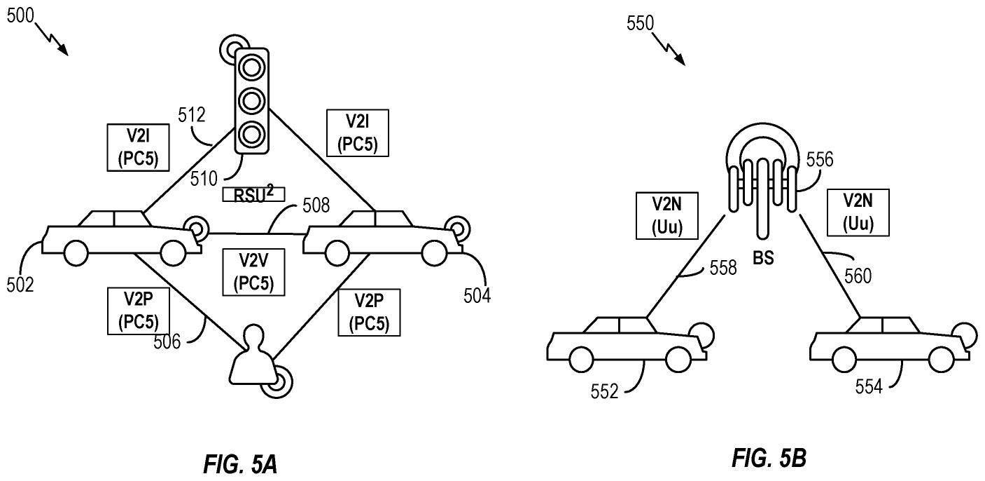

FIG. 5A and FIG. 5B show diagrammatic representations of example V2X systems, in accordance with some aspects of the present disclosure. For example, the vehicles shown in FIG. 5A and FIG. 5B may communicate via sidelink channels and may relay sidelink transmissions as described herein. V2X is a vehicular technology system that enables vehicles to communicate with the traffic and the environment around them using short-range wireless signals, known as sidelink signals.

The V2X systems provided in FIG. 5A and FIG. 5B provide two complementary transmission modes. A first transmission mode (also referred to as mode 4 in LTE communications systems and mode 2 in 5G communications systems), shown by way of example in FIG. 5A, involves direct communications (for example, also referred to as sidelink communications) between participants in proximity to one another in a local area. A second transmission mode (also referred to as mode 3 in LTE communications systems and mode 1 in 5G communications systems), shown by way of example in FIG. 5B, involves network communications through a network, which may be implemented over a Uu interface (for example, a wireless communication interface between a radio access network (RAN) and a UE).

Referring to FIG. 5A, a V2X system 500 (for example, including vehicle-to-vehicle (V2V) communications) is illustrated with two vehicles 502, 504. The first transmission mode allows for direct communication between different participants in a given geographic location. As illustrated, a vehicle can have a wireless communication link 506 with an individual (V2P) (for example, via a UE) through a PC5 interface. Communications between the vehicles 502 and 504 may also occur through a PC5 interface 508. In a like manner, communication may occur from a vehicle 502 to other highway components (for example, roadside unit (RSU) 510), such as a traffic signal or sign (V2I) through a PC5 interface 512. With respect to each communication link illustrated in FIG. 5A, two-way communication may take place between elements, therefore each element may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. These network communications may occur through discrete nodes, such as a BS (e.g., the BS 102), that sends and receives information to and from (for example, relays information between) vehicles 552, 554. The network communications through vehicle to network (V2N) links 558 and 560 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

RSUs, such as RSU 510, may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QOS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

### Aspects Related to Redundancy Mitigation Techniques for Sensor Sharing in Sidelink Communication

As noted above, two or more subordinate entities (e.g., UEs 104) may communicate with each other using sidelink signals. One real-world application of such sidelink communications may include V2V communication in a V2X system in which UEs of two or more vehicles may communicate with each other. In some cases, this type of communication may include the sharing of sensor information of the vehicles participating in the communication. When in certain scenarios or environments, such as driving on a road, sensor sharing may enhance situational awareness for entities in the V2X system (e.g., RSUs, vehicles, vulnerable road users (VRUs), etc.) by sharing objects detected via one or more sensors to improve driving decisions and coordinated maneuvers. In some cases, these detected objects may include, for example, non-cellular V2X vehicles, VRUs, and road obstacles.

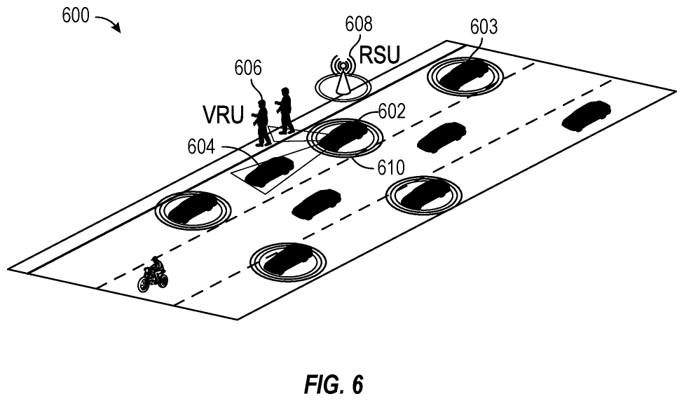

FIG. 6 illustrates an example environment 600 in which a V2X system may be employed. As illustrated, the environment 600 may include a plurality of cellular V2X (CV2X)-capable vehicles (e.g., vehicle 602, vehicle 603), a plurality of non-CV2X vehicles (e.g., vehicle 604), a plurality of VRUs (e.g., VRU 606), and a plurality of RSUs (e.g., RSU 608). In some cases, the vehicle 602 may include the vehicle 502, the vehicle 504, the vehicle 552, the vehicle 554 illustrated in FIGS. 5A and 5B. In some cases, the vehicle 602 may include the UE 104 illustrated in FIG. 1.

In some cases, while operating in the environment 600, the vehicle 602 may sense one or more objects in the environment 600, such as the vehicle 604 and VRU 606, via one or more sensors. In some cases, the one or more sensors may include external sensors for sensing objects external from the vehicle 602 and internal sensors for sensing certain conditions associated with the vehicle 602 itself. In some cases, the external sensors may include, for example, cameras, radar sensors, light detection and ranging (LIDAR) sensors, global navigation satellite system (GNSS) sensors, mapping sensors, and the like. The internal sensors may include, for example, engine monitoring sensors, speed and heading sensors, attitude sensors, and the like.

In some cases, to improve situational awareness in the environment 600 (e.g., improve driving decisions and coordinated maneuvers), the vehicle 602 may decide to transmit a sensor data sharing message (SDSM) 610 to other V2X-capable vehicles (e.g., vehicle 603) or RSUs in the environment 600.

The Society of Automotive Engineers (SAE) has developed standards regarding Personal Safety Messages (PSMs) to enable CV2X-capable UEs held by pedestrians, cyclists, and other vulnerable road users (VRUs) to broadcast location, motion state, path history, and path prediction information to other CV2X devices, such as vehicles and RSUs. Per the standard governing the PSM (SAE J2945/9), PSM transmission frequency is between 1 Hz and 10 Hz, with the exact frequency determined by several criteria based on VRU activity.

The European Telecommunications Standards Institute (ETSI) has developed standards for VRU awareness messages (VAMs) that may be similar to PSMs. Other jurisdictions may develop standards for messages that indicate one or more characteristics (e.g., location, motion state, path history, or path prediction information) of VRUs.

UEs used by VRUs (e.g., pedestrians or cyclists) are typically operated without external power. As such, it is desirable to minimize power consumption of these UEs. Transmission and reception of PSMs and other messages indicating characteristics of VRUs can substantially increase UE power usage, and while there are methods suggested in the SAE standard to modulate the transmission frequency, identifying a technique for a UE to know when such a message should or should not be transmitted may improve UE power consumption and battery utilization.

It is therefore desirable to develop techniques for a UE to determine to initiate or cease transmission of messages indicating VRU characteristics.

### Aspects Related to a UE Determining to Initiate or Cease Transmission of Messages Indicating VRU Characteristics

Aspects of the present disclosure describe techniques for a UE associated with a VRU (also referred to herein as a VRU UE) to determine when it should initiate and cease transmission of messages indicating VRU characteristics (e.g., PSMs or VAMs) based on current environment, paired devices, location, motion state, detected ambient audio, detected proximate vehicles, and detected VRUs.

In addition to potentially reducing UE power consumption, aspects of the present disclosure may cause a reduction of “nuisance” message (e.g., PSM or VAM) transmission; specifically, UEs in cars, busses, trains, and/or subways may not transmit messages that could mislead or cause receiving UEs (e.g., RSUs, vehicles, or other UEs associated with VRUs) to incorrectly interpret the presence of the user, as well as unnecessarily congesting the over-the-air resources.

According to aspects of the present disclosure, a UE may implement one or more algorithms for initiation and cessation of transmission of messages indicating VRU characteristics based on UE-detected environmental information, UE-detected VRU activity, and/or UE historical (e.g., learned) data.

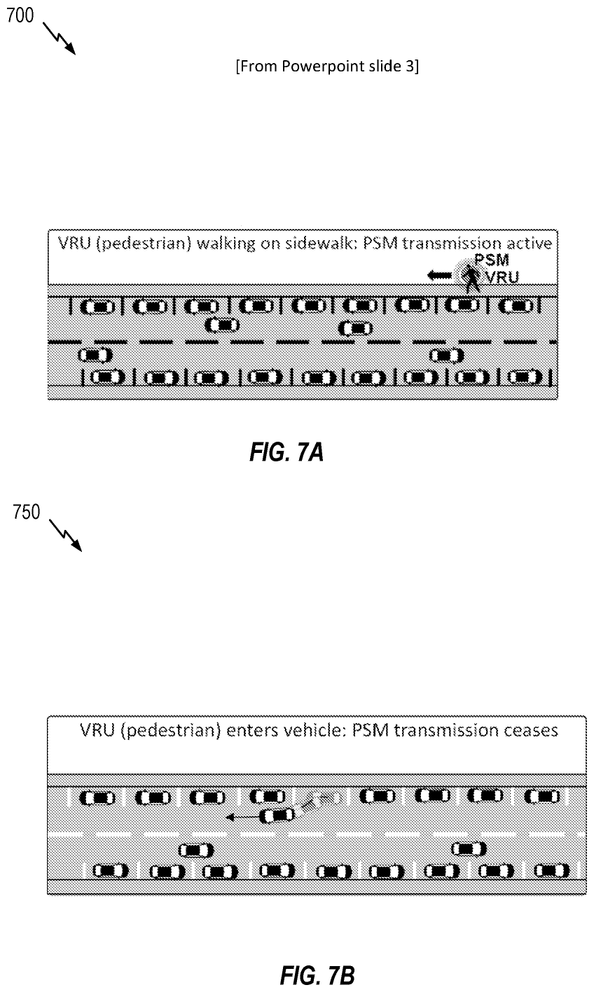

FIGS. 7A and 7B illustrate example scenarios 700, of a UE initiating transmission of messages (e.g., PSMs or VAMs) indicating VRU characteristics, and 750, of a UE ceasing such transmissions, in accordance with aspects of the present disclosure. Scenario 700 illustrates a pedestrian walking, and scenario 750 illustrates the pedestrian subsequently entering a vehicle. In scenario 700, a UE associated with the pedestrian initiates transmission of messages indicating VRU characteristics (e.g., of the pedestrian) while the pedestrian is walking on a sidewalk. Transmission initiation criteria may include one or more of: UE detection (e.g., by detecting periodic motion) of a walking state of the user; obtaining information from a wearable, paired to the UE, that detects a walking state of the user; the user indicating (e.g., via an app or via voice input) to the UE that the user is walking; positioning technology of the UE determining that the UE is in motion at a pedestrian speed (e.g., less than or equal to running speed) on a sidewalk; an indication from external positioning technology (e.g., a cloud-service receiving input from a traffic camera, or an RSU detecting the pedestrian and informing the UE via Uu or V2X) that a user associated with the UE is walking (or jogging or running) on a sidewalk; stored information of known commute paths and time-of-day (e.g., the user walks to a bus stop every day at 7 am); or a combination or fusing of information regarding the above criteria.

In scenario 750 in FIG. 7B, the UE associated with the pedestrian ceases transmission of the messages upon entering the vehicle. Transmission cessation criteria may include one or more of: UE detection that the user is in the vehicle via Bluetooth pairing of the UE with the vehicle, detecting a wired connection to the vehicle, detecting a near-field-communication (NFC) device of the vehicle, or accessing a Wi-Fi hotspot of the vehicle; the user indicating (e.g., via an app on the UE or a voice input) to the UE that the user is driving or riding in a vehicle; the user engaging an app for driving directions on the UE; detecting vehicle-specific speeds, accelerations, and/or decelerations; detecting audio (e.g., sounds of external traffic or of an engine starting) indicating the user is in a vehicle; external positioning technology (e.g., a cloud-service receiving input from a traffic camera or an RSU detecting the user is in a vehicle and informing the UE via Uu or V2X) determining the user associated with the UE is driving or in a vehicle on a street; stored knowledge of known commute paths and time-of-day; and/or a combination or fusing of the above criteria.

In aspects of the present disclosure, a cyclist (e.g., a bicyclist or motorcyclist) may be considered a VRU. According to aspects of the present disclosure, a UE on a bicycle or motorcycle may determine when to initiate and cease transmission of messages indicating VRU characteristics (e.g., PSMs or VAMs) in a manner similar to that described above with regard to a UE associated with a pedestrian.

According to aspects of the present disclosure, a UE associated with a user that is a cyclist may initiate or cease transmission of messages indicating VRU characteristics (e.g., PSMs or VAMs) based on criteria that may include: detection of a cycling state of the user via UE motion (e.g., the UE detecting that the user is pedaling based on the UE's motion); detection of a cycling state via the UE pairing to a wearable that detects that the user is cycling; detection of a cycling state via Bluetooth pairing with a cycling computer and/or a cycling helmet; detection of a cycling state based on image data obtained from a bike-mounted or user-mounted camera; the user indicating (e.g., via an app or the UE or a voice input) that the user is cycling; positioning technology of the UE determining that the UE is in cycling motion via one or more of speed, acceleration, and deceleration; external positioning technology (e.g., cloud-service receiving input from a traffic camera, RSU detecting cycling and informing via Uu or V2X) determining that the user associated with the UE is cycling; stored information of known commute paths and time-of-day (e.g., the user bikes to work every day at 7 am); or detection of messages indicating VRU characteristics (e.g., PSMs or VAMs) from other cyclists (for example, a group of riders in a peloton); a combination or fusing of any of the above inputs.

In aspects of the present disclosure, one or more algorithms for initiating or ceasing transmission of messages indicating VRU characteristics may be implemented as software, firmware, and/or hardware in a UE.

### Example Operations of Entities in a Communications Network

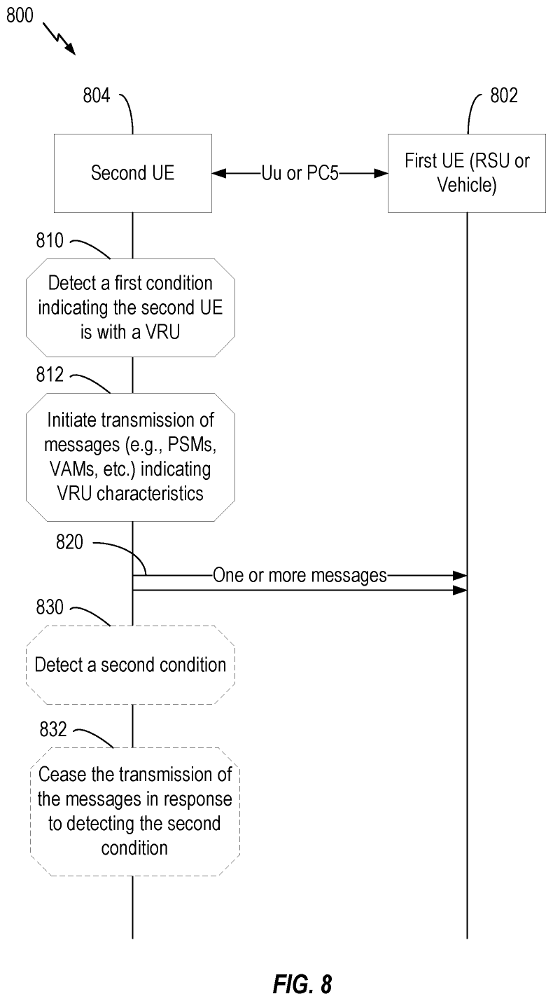

FIG. 8 depicts a process flow 800 for communications in a network between a first user equipment (UE) 802, such as an RSU or vehicle, 802 and a second UE 804. In some aspects, the first UE 802 and the second UE 804 may be examples of UE 104 depicted and described with respect to FIGS. 1 and 3. However, in other aspects, second UE 804 may be another type of wireless communications device and first UE 802 may be another type of network entity or network node, such as those described herein.

At 810, the second UE detects a first condition indicating that the second UE is associated with a VRU. FIGS. 6 and 7A both illustrate one or more UEs that may detect such a first condition.

At 812, the second UE initiates transmission of messages (e.g., PSMs or VAMs) indicating VRU characteristics of the VRU associated with the second UE. For example, the UE associated with the user 606 in FIG. 6 may detect that the user is walking along the sidewalk.

At 820, the second UE transmits one or more messages indicating the VRU characteristics. As shown, the messages may be received by one or more RSUs or UEs of vehicles. Messages from the UE of the user 606 in FIG. 6 may be received by the RSU 608 and/or by one or more of the vehicles 602 and 603.

At 830, the second UE optionally detects a second condition. The second condition may indicate that the user associated with the second UE is no longer a VRU. For example, the UE associated with the user in FIG. 7B may detect that the user has entered a vehicle.

At 832, the second UE optionally ceases the transmission of the messages in response to detecting the second condition.

### Example Operations at a User Equipment

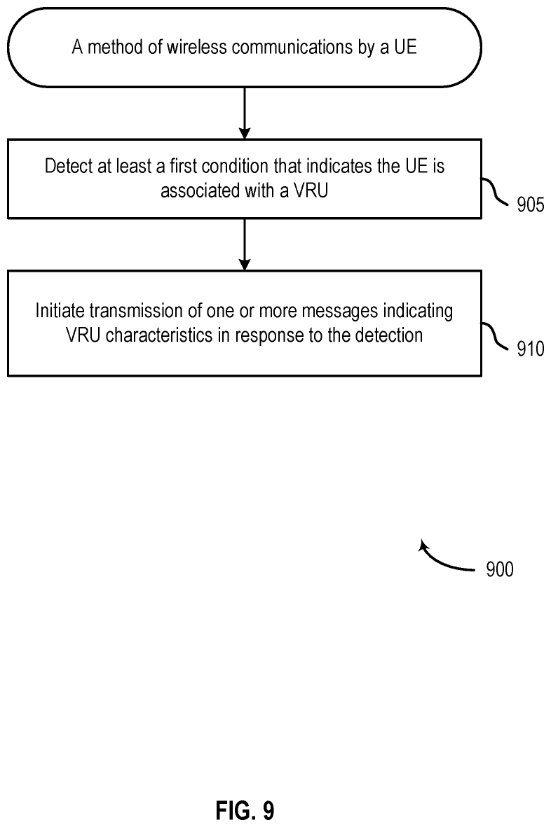

FIG. 9 shows an example of a method 900 of wireless communications by a UE, such as a UE 104 of FIGS. 1 and 3.

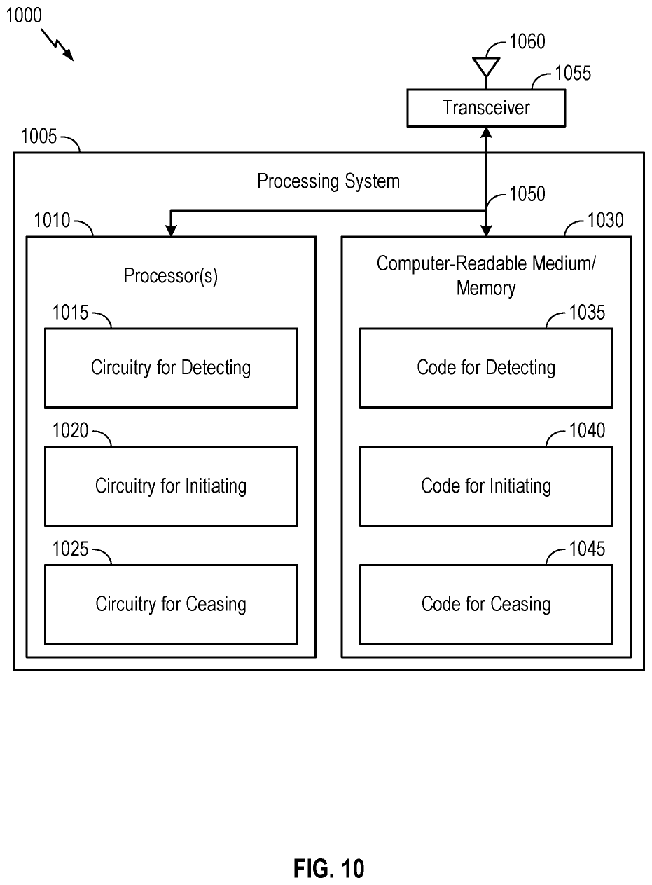

Method 900 begins at step 905 with detecting at least a first condition that indicates the UE is associated with a VRU. In some cases, the operations of this step refer to, or may be performed by, circuitry for detecting and/or code for detecting as described with reference to FIG. 10.

Method 900 then proceeds to step 910 with initiating transmission of one or more messages indicating VRU characteristics in response to the detection. In some cases, the operations of this step refer to, or may be performed by, circuitry for initiating and/or code for initiating as described with reference to FIG. 10.

In some aspects, the one or more messages comprise at least one of: a PSM or a VAM.

In some aspects, the at least the first condition indicates a type of movement of a user associated with the UE.

In some aspects, the at least the first condition comprises at least one of: an input from the user indicating the type of movement of the user; or activation of an application associated with the type of movement of the user.

In some aspects, the at least the first condition comprises the UE moving at a speed less than or equal to a running speed for the user and along a sidewalk.

In some aspects, the at least the first condition comprises signaling from a wearable device paired with the UE.

In some aspects, the at least the first condition comprises signaling from a system that detects, independent of the UE, a type of movement of the user associated with the UE.

In some aspects, the system comprises at least one of: a traffic camera that detects the user; or a RSU that detects the user.

In some aspects, the system detects the type of movement of the user further based on external positioning technology.

In some aspects, the at least the first condition comprises a comparison of stored information regarding activities of a user, associated with the UE, with current activities of the user.

In some aspects, the stored information comprises a commute path of the user.

In some aspects, the at least the first condition comprises the UE moving at a cycling speed or with a cycling acceleration.

In some aspects, the at least the first condition comprises the UE being paired with a device associated with cycling.

In some aspects, the at least the first condition comprises a video signal obtained from a camera mounted on a bicycle or a helmet of the user.

In some aspects, the at least the first condition comprises one or more other messages transmitted by other UEs of one or more cyclists.

In some aspects, the one or more other messages comprise at least one of: a PSM or a VAM.

In some aspects, the method 900 further includes detecting at least a second condition. In some cases, the operations of this step refer to, or may be performed by, circuitry for detecting and/or code for detecting as described with reference to FIG. 10.

In some aspects, the method 900 further includes ceasing the transmission of the one or more messages in response to the detection of the at least the second condition. In some cases, the operations of this step refer to, or may be performed by, circuitry for ceasing and/or code for ceasing as described with reference to FIG. 10.

In some aspects, the at least the second condition comprises a user, associated with the UE, being in a vehicle.

In some aspects, the at least the second condition comprises at least one of: the UE being paired with the vehicle via Bluetooth; the UE being physically connected with the vehicle; presence of a NFC device of the vehicle; or presence of a Wi-Fi hotspot of the vehicle.

In some aspects, the at least the second condition comprises a user, associated with the UE, driving a vehicle.

In some aspects, the at least the second condition comprises at least one of: an input from the user indicating the user is driving; or activation of an application associated with the user driving.

In some aspects, the at least the second condition comprises the UE moving at a speed greater than a running speed of a user associated with the UE or with a vehicle acceleration.

In some aspects, the at least the second condition comprises a sound indicating a user, associated with the UE, is in a vehicle.

In some aspects, the at least the second condition comprises signaling from a system that detects, independent of the UE, that a user, associated with the UE, is in a vehicle.

In some aspects, the system comprises at least one of: a traffic camera that detects the user; or a RSU that detects the user.

In some aspects, the system detects that the user is in the vehicle further based on external positioning technology.

In some aspects, the at least the second condition comprises a comparison of stored information regarding activities of a user, associated with the UE, with current activities of the user.

In some aspects, the stored information comprises a commute path of the user.

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

### Example Communications Device

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to the transceiver 1055 (e.g., a transmitter and/or a receiver). The transceiver 1055 is configured to transmit and receive signals for the communications device 1000 via the antenna 1060, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, cause the one or more processors 1010 to perform the method 900 described with respect to FIG. 9, or any aspect related to it. Note that reference to a processor performing a function of communications device 1000 may include one or more processors 1010 performing that function of communications device 1000.

In the depicted example, computer-readable medium/memory 1030 stores code (e.g., executable instructions), such as code for detecting 1035, code for initiating 1040, and code for ceasing 1045. Processing of the code for detecting 1035, code for initiating 1040, and code for ceasing 1045 may cause the communications device 1000 to perform the method 900 described with respect to FIG. 9, or any aspect related to it.

The one or more processors 1010 include circuitry configured to implement (e.g., execute) the code stored in the computer-readable medium/memory 1030, including circuitry such as circuitry for detecting 1015, circuitry for initiating 1020, and circuitry for ceasing 1025. Processing with circuitry for detecting 1015, circuitry for initiating 1020, and circuitry for ceasing 1025 may cause the communications device 1000 to perform the method 900 described with respect to FIG. 9, or any aspect related to it.

Various components of the communications device 1000 may provide means for performing the method 900 described with respect to FIG. 9, or any aspect related to it. For example, means for transmitting, sending, or outputting for transmission may include transceivers 354 and/or antenna(s) 352 of the UE 104 illustrated in FIG. 3 and/or the transceiver 1055 and the antenna 1060 of the communications device 1000 in FIG. 10. Means for receiving or obtaining may include transceivers 354 and/or antenna(s) 352 of the UE 104 illustrated in FIG. 3 and/or the transceiver 1055 and the antenna 1060 of the communications device 1000 in FIG. 10. Means for detecting, initiating, and ceasing may include one or more of the controller/processor 380, memory 382, and other various processors of FIG. 3 and/or the processor(s) 1010 and computer-readable medium 1030 of FIG. 10.

### EXAMPLE CLAUSES

Implementation examples are described in the following numbered clauses:

Clause 1: A method of wireless communications by a UE, comprising: detecting at least a first condition that indicates the UE is associated with a VRU; and initiating transmission of one or more messages indicating VRU characteristics in response to the detection.

Clause 2: The method of Clause 1, wherein the one or more messages comprise at least one of: a PSM or a VAM.

Clause 3: The method of any one of Clauses 1 and 2, wherein the at least the first condition indicates a type of movement of a user associated with the UE.

Clause 4: The method of Clause 3, wherein the at least the first condition comprises at least one of: an input from the user indicating the type of movement of the user; or activation of an application associated with the type of movement of the user.

Clause 5: The method of any one of Clauses 1-4, wherein the at least the first condition comprises the UE moving at a speed less than or equal to a running speed for the VRU and along a sidewalk.

Clause 6: The method of any one of Clauses 1-5, wherein the at least the first condition comprises signaling from a wearable device paired with the UE.

Clause 7: The method of any one of Clauses 1-6, wherein the at least the first condition comprises signaling from a system that detects, independent of the UE, a type of movement of the VRU associated with the UE.

Clause 8: The method of Clause 7, wherein the system comprises at least one of: a traffic camera that detects the VRU; or a RSU that detects the VRU.

Clause 9: The method of Clause 7, wherein the system detects the type of movement of the VRU further based on external positioning technology.

Clause 10: The method of any one of Clauses 1-9, wherein the at least the first condition comprises a comparison of stored information regarding activities of a user, associated with the UE, with current activities of the user.

Clause 11: The method of Clause 10, wherein the stored information comprises a commute path of the user.

Clause 12: The method of any one of Clauses 1-11, wherein the at least the first condition comprises the UE moving at a cycling speed or with a cycling acceleration.

Clause 13: The method of any one of Clauses 1-12, wherein the at least the first condition comprises the UE being paired with a device associated with cycling.

Clause 14: The method of any one of Clauses 1-13, wherein the at least the first condition comprises a video signal obtained from a camera mounted on a bicycle or a helmet of the VRU.

Clause 15: The method of any one of Clauses 1-14, wherein the at least the first condition comprises one or more other messages transmitted by other UEs of one or more cyclists.

Clause 16: The method of Clause 15, wherein the one or more other messages comprise at least one of: a PSM or a VAM.

Clause 17: The method of any one of Clauses 1-16, further comprising: detecting at least a second condition; and ceasing the transmission of the one or more messages in response to the detection of the at least the second condition.

Clause 18: The method of Clause 17, wherein the at least the second condition comprises a user, associated with the UE, being in a vehicle.

Clause 19: The method of Clause 18, wherein the at least the second condition comprises at least one of: the UE being paired with the vehicle via Bluetooth; the UE being physically connected with the vehicle; presence of a NFC device of the vehicle; or presence of a Wi-Fi hotspot of the vehicle.

Clause 20: The method of Clause 17, wherein the at least the second condition comprises a user, associated with the UE, driving a vehicle.

Clause 21: The method of Clause 20, wherein the at least the second condition comprises at least one of: an input from the user indicating the user is driving; or activation of an application associated with the user driving.

Clause 22: The method of Clause 17, wherein the at least the second condition comprises the UE moving at a speed greater than a running speed of a user associated with the UE or with a vehicle acceleration.

Clause 23: The method of Clause 17, wherein the at least the second condition comprises a sound indicating a user, associated with the UE, is in a vehicle.

Clause 24: The method of Clause 17, wherein the at least the second condition comprises signaling from a system that detects, independent of the UE, that a user, associated with the UE, is in a vehicle.

Clause 25: The method of Clause 24, wherein the system comprises at least one of: a traffic camera that detects the user; or a RSU that detects the user.

Clause 26: The method of Clause 25, wherein the system detects that the user is in the vehicle further based on external positioning technology.

Clause 27: The method of Clause 17, wherein the at least the second condition comprises a comparison of stored information regarding activities of a user, associated with the UE, with current activities of the user.

Clause 28: The method of Clause 27, wherein the stored information comprises a commute path of the VRU.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communications by a user equipment (UE), comprising:
detecting at least a first condition that indicates the UE is associated with a vulnerable road user (VRU); and
initiating transmission of one or more messages indicating VRU characteristics in response to the detection.

2. The method of claim 1, wherein the one or more messages comprise at least one of: a personal safety message (PSM) or a VRU Awareness Message (VAM).

3. The method of claim 1, wherein the at least the first condition indicates a type of movement of a user associated with the UE.

4. The method of claim 3, wherein the at least the first condition comprises at least one of:
an input from the user indicating the type of movement of the user; or
activation of an application associated with the type of movement of the user.

5. The method of claim 1, wherein the at least the first condition comprises the UE moving at a speed less than or equal to a running speed for the VRU and along a sidewalk.

6. The method of claim 1, wherein the at least the first condition comprises signaling from a wearable device paired with the UE.

7. The method of claim 1, wherein the at least the first condition comprises signaling from a system that detects, independent of the UE, a type of movement of the VRU associated with the UE.

8. The method of claim 7, wherein the system comprises at least one of:
a traffic camera that detects the VRU; or
a roadside service unit (RSU) that detects the VRU.

9. The method of claim 7, wherein the system detects the type of movement of the VRU further based on external positioning technology.

10. The method of claim 1, wherein the at least the first condition comprises a comparison of stored information regarding activities of a user, associated with the UE, with current activities of the user.

11. The method of claim 10, wherein the stored information comprises a commute path of the user.

12. The method of claim 1, wherein the at least the first condition comprises the UE moving at a cycling speed or with a cycling acceleration.

13. The method of claim 1, wherein the at least the first condition comprises the UE being paired with a device associated with cycling.

14. The method of claim 1, wherein the at least the first condition comprises a video signal obtained from a camera mounted on a bicycle or a helmet of the user.

15. The method of claim 1, wherein the at least the first condition comprises one or more other messages transmitted by other UEs of one or more cyclists.

16. The method of claim 15, wherein the one or more other messages comprise at least one of: a personal safety message (PSM) or a VRU Awareness Message (VAM).

17. The method of claim 1, further comprising:
detecting at least a second condition; and
ceasing the transmission of the one or more messages in response to the detection of the at least the second condition.

18. The method of claim 17, wherein the at least the second condition comprises a user, associated with the UE, being in a vehicle.

19. The method of claim 18, wherein the at least the second condition comprises at least one of:
the UE being paired with the vehicle via Bluetooth;
the UE being physically connected with the vehicle;
presence of a near-field-communication (NFC) device of the vehicle; or
presence of a Wi-Fi hotspot of the vehicle.

20. The method of claim 17, wherein the at least the second condition comprises a user, associated with the UE, driving a vehicle.

21. The method of claim 20, wherein the at least the second condition comprises at least one of:
an input from the user indicating the user is driving; or
activation of an application associated with the user driving.

22. The method of claim 17, wherein the at least the second condition comprises the UE moving at a speed greater than a running speed of a user associated with the UE or with a vehicle acceleration.

23. The method of claim 17, wherein the at least the second condition comprises a sound indicating a user, associated with the UE, is in a vehicle.

24. The method of claim 17, wherein the at least the second condition comprises signaling from a system that detects, independent of the UE, that a user, associated with the UE, is in a vehicle.

25. The method of claim 24, wherein the system comprises at least one of:
a traffic camera that detects the user; or
a roadside service unit (RSU) that detects the user.

26. The method of claim 25, wherein the system detects that the user is in the vehicle further based on external positioning technology.

27. The method of claim 17, wherein the at least the second condition comprises a comparison of stored information regarding activities of a user, associated with the UE, with current activities of the user.

28. The method of claim 27, wherein the stored information comprises a commute path of the user.

29. A user equipment (UE) configured for wireless communications, comprising:
a memory comprising computer-executable instructions; and
a processor configured to execute the computer-executable instructions and cause the UE to:
detect at least a first condition that indicates the UE is associated with a vulnerable road user (VRU); and
initiate transmission of one or more messages indicating VRU characteristics in response to detecting the at least the first condition.

30. A non-transitory computer-readable medium comprising executable instructions that, when executed by a processor of an apparatus, cause the apparatus to:
detect at least a first condition that indicates the apparatus is associated with a vulnerable road user (VRU); and
initiate transmission of one or more messages indicating VRU characteristics in response to detecting the at least the first condition.
